(19) United States
(12) Patent Application Publication
(10) Pub. No.: US 2020/0037398 A1
(43) Pub. Date: Jan. 30, 2020

(54) COMMUNICATION CONTROL METHOD

(71) Applicant: KYOCERA Corporation, Kyoto (JP)

(72) Inventors: Hiroyuki ADACHI, Kawasaki-shi, Kanagawa (JP); Masato FUJISHIRO, Yokohama-shi, Kanagawa (JP); Chiharu YAMAZAKI, Ota-ku, Tokyo (JP); Kugo MORITA, Yokohama-shi, Kanagawa (JP)

(73) Assignee: KYOCERA Corporation, Kyoto (JP)

(21) Appl. No.: 16/337,707

(22) PCT Filed: Sep. 13, 2017
(86) PCT No.: PCT/JP2017/032975

§ 371 Date: Mar. 28, 2019

Related U.S. Application Data
(60) Provisional application No. 62/402,230, filed on Sep. 30, 2016.

(51) Int. Cl. H04W 92/18; H04B 7/155; H04W 72/12; H04W 72/04; H04W 88/04; H04B 7/26

(52) U.S. Cl. CPC H04W 92/18; H04B 7/15542; H04W 72/12; H04L 2001/0097; H04W 88/04; H04B 7/2656; H04W 72/0413; H04W 72/042

(57) ABSTRACT

In a communication control method according to one embodiment, a first radio terminal executes, control to establish a predetermined connection through a second radio terminal that is a relay terminal. The predetermined connection is used for transmitting control information related to the first radio terminal between the first radio terminal and a base station. The first radio terminal starts control to establish the predetermined connection, in response to receiving authorization information indicating that establishing the predetermined connection is possible.

### TECHNICAL FIELD

The present invention relates to a communication control method.

### BACKGROUND ART

In the 3rd Generation Partnership Project (3GPP) that is a mobile communication system standardization project, the formulation of specifications of a proximity service (ProSe: Proximity-based Service) has been developed (see Non Patent Literature 1).

In ProSe, a specific radio terminal (ProSe UE-to-Network Relay) is capable of relaying traffic between another radio terminal (Remote UE) and a network.

### CITATION LIST

### Non Patent Literature

Non patent Literature 1: 3GPP technical specification “TS 36.300 V13.4.0” on Jul. 7, 2016

### SUMMARY OF INVENTION

In a communication control method according to one embodiment, a first radio terminal executes, control to establish a predetermined connection through a second radio terminal that is a relay terminal. The predetermined connection is used for transmitting control information related to the first radio terminal between the first radio terminal and a base station. The first radio terminal starts control to establish the predetermined connection, in response to receiving authorization information indicating that establishing the predetermined connection is possible.

In a communication control method according to one embodiment, a first radio terminal transmits to the base station, uplink information through an uplink path from the first radio terminal to the base station via a second radio terminal that is a relay terminal. The first radio terminal receives from the base station, downlink information through a downlink path from the base station to the first radio terminal not via the second radio terminal. The first radio terminal receives specification information specifying a first uplink path or a second uplink path, as a path through which PUCCH related information is to be transmitted on a physical uplink control channel. The first uplink path is a path from the first radio terminal to the base station via the second radio terminal. The second uplink path is a path from the first radio terminal to the base station not via the second radio terminal. The first radio terminal transmits the PUCCH related information to the base station through the first uplink path or the second uplink path, based on the specification information.

### BRIEF DESCRIPTION OF DRAWINGS

FIG. 1 is a diagram illustrating a configuration of an LTE system.

FIG. 2 is a protocol stack diagram of a radio interface in the LTE system.

FIG. 3 is a configuration diagram of a radio frame used in the LTE system.

FIG. 4 is a diagram for describing a relay using a proximity service.

FIG. 5 is a diagram illustrating an example of a control plane relay protocol stack.

FIG. 6 is a diagram illustrating an example of a control plane relay protocol stack.

FIG. 7 is a block diagram of a UE 100.

FIG. 8 is a block diagram of an eNB 200.

FIG. 9 is a diagram for describing a downlink path.

FIG. 10 is a diagram for describing an uplink path.

FIG. 11 is a diagram for describing operation example 1.

FIG. 12 is a diagram for describing operation example 2.

FIG. 13 is a diagram for describing operation example 3.

FIG. 14 is a diagram for describing the operation example 3.

FIG. 15 is a diagram for describing operation example 4.

FIG. 16 is a diagram for describing operation example 4.

FIG. 17 is a diagram for describing the operation example 4.

FIG. 18 is a diagram for describing operation example 5.

FIG. 19 is a diagram for describing operation example 6.

FIG. 20 is a diagram for describing operation example 6.

FIG. 21 is a diagram for describing operation example 7.

FIG. 22 is a diagram for describing an operation example 8.

FIG. 23 is a diagram for describing a remote UE in an extended coverage.

### OVERVIEW OF EMBODIMENTS

In a communication control method according to one embodiment, a first radio terminal executes, control to establish a predetermined connection through a second radio terminal that is a relay terminal. The predetermined connection is used for transmitting control information related to the first radio terminal between the first radio terminal and a base station. The first radio terminal starts control to establish the predetermined connection, in response to receiving authorization information indicating that establishing the predetermined connection is possible.

The first radio terminal may receive the authorization information from the base station.

The first radio terminal may receive the authorization information from the second radio terminal.

The first radio terminal may receive specification information indicating a first path or a second path as a downlink path. The first path may be a path from the base station to the first radio terminal via the second radio terminal. The second path may be a path from the base station to the first radio terminal not via the second radio terminal. The first radio terminal may receive downlink information from the base station through the first path or the second path, based on the specification information.

In a communication control method according to one embodiment, a first radio terminal transmits to the base station, uplink information through an uplink path from the first radio terminal to the base station via a second radio terminal that is a relay terminal. The first radio terminal receives from the base station, downlink information through a downlink path from the base station to the first radio terminal not via the second radio terminal. The first radio terminal receives specification information specifying a first uplink path or a second uplink path, as a path through which PUCCH related information is to be transmitted on a physical uplink control channel. The first uplink path is a path from the first radio terminal to the base station via the second radio terminal. The second uplink path is a path from the first radio terminal to the base station not via the second radio terminal. The first radio terminal transmits the PUCCH related information to the base station through the first uplink path or the second uplink path, based on the specification information.

The PUCCH related information may be at least one of acknowledgment information, channel state information, and a scheduling request in response to the downlink information.

The PUCCH related information may be acknowledgment information in response to the downlink information. The second radio terminal may acquire the downlink information from the base station. The first radio terminal may transmit the acknowledgment information to the second radio terminal. The second radio terminal may retransmit the downlink information to the first radio terminal, instead of the base station, in response to the acknowledgment information being negative information.

The second radio terminal may receive an identifier for acquiring the downlink information from the first radio terminal or the base station. The second radio terminal may acquire the downlink information using the identifier.

The PUCCH related information may be acknowledgment information in response to the downlink information. The base station may notify the first radio terminal of a reception period of the acknowledgment information, in a case where the base station receives the acknowledgment information from the first radio terminal through the first uplink path. The base station may start retransmission of the downlink information, in response that the base station is unable to receive the acknowledgment information even after the reception period has elapsed.

The PUCCH related information may be acknowledgment information in response to the downlink information. The second radio terminal may receive the acknowledgment information from the first radio terminal. The second radio terminal may transmit to the base station, the acknowledgment information in preference to other information to be transmitted to the base station.

The first radio terminal may receive setting information. The setting information may indicate a setting for using a radio resource allocated from the base station, in a case where the uplink information is transmitted to the second radio terminal. The first radio terminal may autonomously select a radio resource from a resource pool, in a case where the uplink information is generated before the radio resource is allocated from the base station. The first radio terminal may transmit to the second radio terminal, a scheduling request for requesting a radio resource to the base station, by using the selected radio resource.

### Embodiments

(Mobile Communication System)

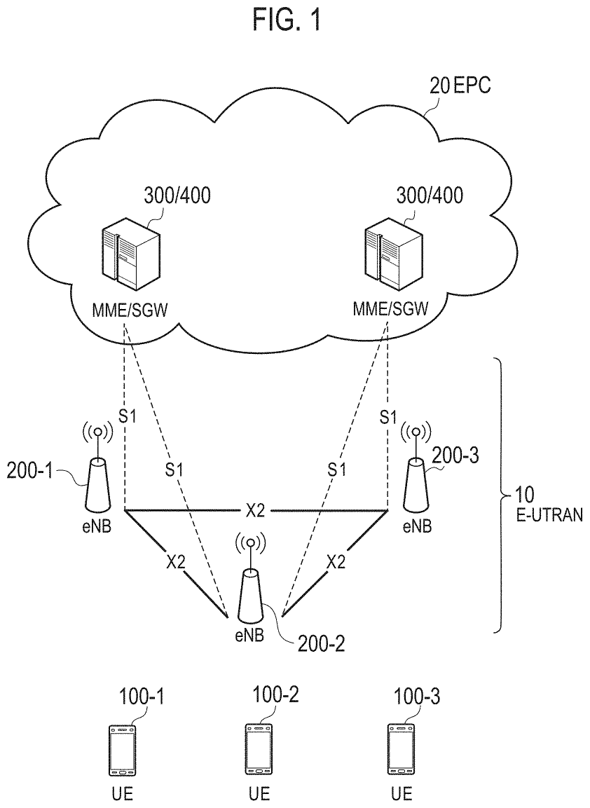

The configuration of the mobile communication system according to the embodiment will be described. FIG. 1 is a diagram illustrating a configuration of a Long Term Evolution (LTE) system.

As illustrated in FIG. 1, the LTE system includes a User Equipment (UE) 100, an Evolved-Universal Terrestrial Radio Access Network (E-UTRAN) 10, and an Evolved Packet Core (EPC) 20.

The UE 100 corresponds to a communication apparatus (radio terminal). The UE 100 is a mobile communication apparatus. The UE 100 performs radio communication with a cell (later described eNB 200). The configuration of the UE 100 will be described later.

The E-UTRAN 10 corresponds to a radio access network. The E-UTRAN 10 includes an evolved Node-B (eNB) 200. The eNB 200 corresponds to a base station. The eNBs 200 are connected to each other via an X2 interface. The configuration of the eNB 200 will be described later.

The eNB 200 manages one or a plurality of cells. The eNB 200 performs radio communication with the UE 100 that has established connection with cells managed by the eNB 200. The eNB 200 has a radio resource management (RRM) function, a routing function of user data (hereinafter, simply referred to as “data”), a measurement control function for mobility control and scheduling, and the like. The “cell” may be used as a term indicating the minimum unit of a radio communication area. The “cell” may be used as a term indicating a function of performing radio communication with the UE 100.

The EPC 20 corresponds to a core network. The EPC 20 may constitute a network together with the E-UTRAN 10. The EPC 20 includes an MME (Mobility Management Entity) 300 and an SGW (Serving Gateway) 400

The MME 300 performs, for example, various kinds of mobility control for the UE 100. The SGW 400 performs, for example, data transfer control. The MME 300 and the SGW 400 are connected to the eNB 200 via a S1 interface.

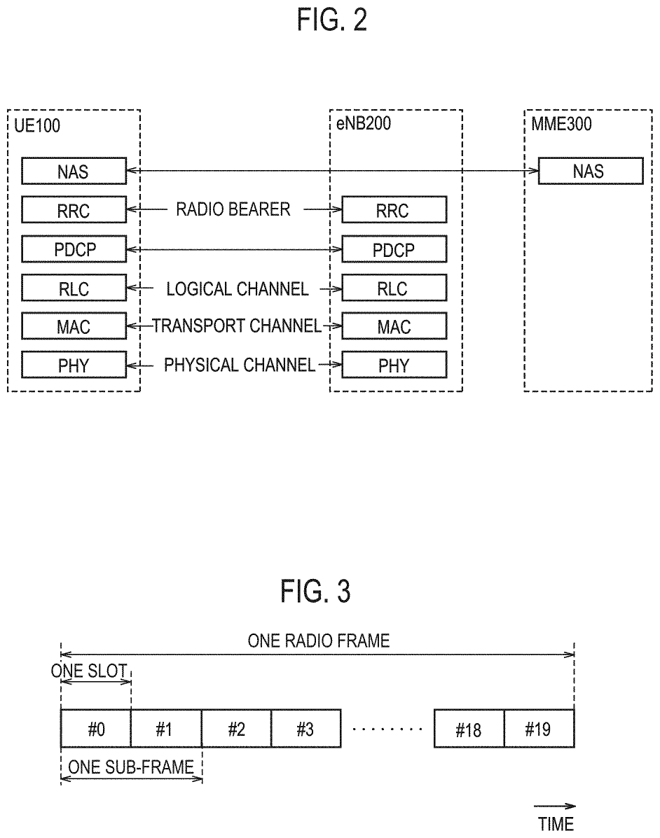

FIG. 2 is a diagram illustrating protocol stack of a radio interface in the LTE system. As illustrated in FIG. 2, a radio interface protocol is separated into first to third layers of an Open Systems Interconnection (OSI) reference model. The first layer is a physical (PHY) layer. The second layer includes a Medium Access Control (MAC) layer, a Radio Link Control (RLC) layer, and a Packet Data Convergence Protocol (PDCP) layer. The third layer includes a Radio Resource Control (RRC) layer.

The physical layer performs encoding/decoding, modulation/demodulation, antenna mapping/demapping, and resource mapping/demapping. Between the physical layer of the UE 100 and the physical layer of the eNB 200, data and control signal are transferred via a physical channel.

The MAC layer performs data priority control, retransmission processing using a hybrid automatic repeat request (ARQ) (HARQ), a random access procedure, and the like. Between the MAC layer of the UE 100 and the MAC layer of the eNB 200, data and control signal are transferred via a transport channel. The MAC layer of the eNB 200 includes a scheduler (MAC scheduler). The scheduler decides a transport format (transport block size and modulation and coding schemes (MCS)) of uplink and downlink, and a resource block to be allocated to the UE 100.

The RLC layer transfers data to an RLC layer on a reception side using the functions of the MAC layer and the physical layer. Between the RLC layer of the UE 100 and the RLC layer of the eNB 200, data and control information are transferred via a logical channel.

The PDCP layer performs header compression/decompression, and encryption/decryption.

The RRC layer is defined only in a control plane handling control signal. Between the RRC layer of the UE 100 and the RRC layer of the eNB 200, messages (RRC messages) for various configurations are transferred. The RRC layer controls the logical channel, the transport channel, and the physical channel in response to establishment, re-establishment, and release of a radio bearer. If there is connection (RRC connection) between the RRC of the UE 100 and the RRC of the eNB 200, the UE 100 is in an RRC connected state. If there is not a connection (RRC connection) between the RRC of the UE 100 and the RRC of the eNB 200, the UE 100 is in an RRC idle state.

A non-access stratum (NAS) layer located above the RRC layer performs, for example, session management, mobility management, and the like.

FIG. 3 is a configuration diagram of a radio frame used in the LTE system. In the LTE system, Orthogonal Frequency Division Multiple Access (OFDMA) is applied to downlink. In the LTE system, Single Carrier Frequency Division Multiple Access (SC-FDMA) is applied to uplink.

As illustrated in FIG. 3, a radio frame is constituted by ten subframes arranged in a time direction. Each subframe is constituted by two slots arranged in the time direction. The length of each subframe is 1 ms, and the length of each slot is 0.5 ms. Each subframe includes a plurality of resource blocks (RBs) in a frequency direction. Each subframe includes a plurality of symbols in the time direction. Each resource block includes a plurality of subcarriers in the frequency direction. One resource element (RE) is constituted by one symbol and one subcarrier. Radio resources (time/frequency resources) are allocated to the UE 100. In the frequency direction, radio resources (frequency resources) are constituted by resource blocks. In the time direction, radio resources (time resources) are constituted by subframes (or slots).

In the downlink, the section of the first several symbols of each subframe is an area that can be used as a physical downlink control channel (PDCCH) for transmitting a downlink control signal. The remaining part of each subframe is an area that can be used as a physical downlink shared channel (PDSCH) for transmitting downlink data.

In the uplink, both end portions in the frequency direction in each subframe are areas usable as a Physical Uplink Control Channel (PUCCH) for transmitting an uplink control signal. The remaining part of each subframe is an area that can be used as a physical uplink shared channel (PUSCH) for transmitting uplink data.

(Proximity-Based Service)

Proximity-based services (ProSes) will be described. The proximity-based service is a service that can be provided by a 3GPP system, based on communication devices (for example, UEs 100) in the vicinity of each other.

In the ProSe, various types of radio signals are transmitted and received via a direct radio link between nodes (for example, between UEs), without passing through the eNB 200. The direct radio link in ProSe is called “sidelink”.

The sidelink may be an interface for sidelink communication and sidelink discovery (for example, an interface between a UE and a UE). The sidelink communication is a function (AS functionality) for enabling ProSe direct communication (hereinafter, appropriately referred to as “direct communication”). The sidelink discovery is a function (AS functionality) for enabling ProSe direct discovery (hereinafter, appropriately referred to as “direct discovery”).

The sidelink corresponds to a PC5 interface (PC5 connection). The PC5 is a reference point between ProSe usable UEs (ProSe-enabled UE) used for a control plane and a user plane for the ProSe direct discovery, the ProSe direct communication, and a ProSe UE-to-Network relay.

For modes of the ProSe, “direct discovery (Direct Discovery)”, “direct communication (Direct Communication)”, and “Relay” are defined. “Relay” will be described later.

The direct discovery is a mode of searching for a partner destination by directly transmitting, between the UEs, a discovery message (discovery signal) that does not specify a specific destination. The direct discovery is a procedure for discovering another UE in the vicinity of the UE by using a direct radio signal in E-UTRA (Evolved Universal Terrestrial Radio Access) via the PC5. Alternatively, the direct discovery is a procedure adopted by a UE 100 capable of executing the proximity-based service for discovering another UE 100 capable of executing the proximity-based service by using only a capability of the two UEs 100 with the help of the E-UTRA technology. The direct discovery is supported only if the service is provided to the UE 100 by the E-UTRAN (eNB 200 (cell)). The service can be provided by the E-UTRAN if the UE 100 is connected to the cell (eNB 200) or exists in the cell.

A resource allocation type for the transmission (announcement) of the discovery message (discovery signal) includes “Type 1” and “Type 2 (Type 2B)”. In “Type 1”, the UE 100 selects a radio resource. In “Type 2 (Type 2B)”, the eNB 200 allocates a radio resource. In Type 1, the UE 100 may select a radio resource from resource pools provided by the eNB 200.

A “Sidelink Direct Discovery” protocol stack includes a physical (PHY) layer, a MAC layer, and the ProSe protocol. Between the physical layer of a UE (A) and the physical layer of a UE (B), a discovery signal is transmitted via a physical channel called a physical sidelink discovery channel (PSDCH). Between the MAC layer of the UE (A) and the MAC layer of the UE (B), a discovery signal is transmitted via a transport channel called a sidelink discovery channel (SL-DCH).

The direct communication is a mode in which data is directly transmitted between the UEs by specifying a specific destination (destination group). The direct communication is communication between two or more UEs capable of executing the proximity-based services through user plane transmission in which the E-UTRA technology is used via a path without passing through any network node.

A resource allocation type of the direct communication includes “Mode 1” and “Mode 2”. In “Mode 1”, the eNB 200 assigns a radio resource of the direct communication. In “Mode 2”, the UE 100 selects a radio resource of the direct communication. In Mode 2, the UE 100 may select a radio resource from the resource pools provided by the eNB 200.

A direct communication protocol stack includes a physical (PHY) layer, a MAC layer, an RLC layer, and a PDCP layer. Between the physical layer of the UE (A) and the physical layer of the UE (B), a control signal is transmitted via a physical sidelink control channel (PSCCH), and data is transmitted via a physical sidelink shared channel (PSSCH). A synchronization signal and the like may be transmitted via a physical sidelink broadcast channel (PSBCH). Between the MAC layer of the UE (A) and the MAC layer of the UE (B), data is transmitted via a transport channel called a sidelink shared channel (SL-SCH). Between the RLC layer of the UE (A) and the RLC layer of the UE (B), data is transmitted via a logical channel called a sidelink traffic channel (STCH).

(Relay Using Proximity-Based Service)

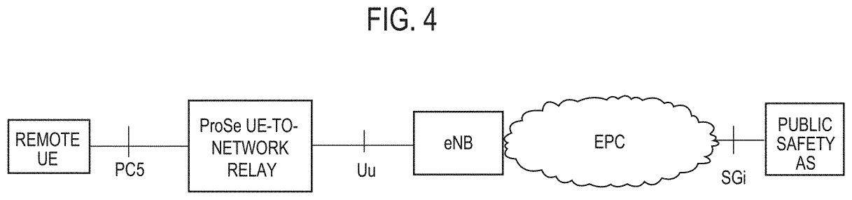

A relay using the proximity-based service (ProSe relay) will be described with reference to FIG. 4. FIG. 4 is a diagram for describing the relay using the proximity-based service according to the embodiment.

In FIG. 4, a remote UE (Remote UE) is a UE 100 that communicates with a PDN (Packet Data Network) via a relay UE (ProSe UE-to-Network Relay). The remote UE may be a UE for public safety (ProSe-enabled Public Safety UE).

The “ProSe-enabled Public Safety UE” is configured such that an HPLMN (Home Public Land Mobile Network) is authorised for use for public safety. The “ProSe-enabled Public Safety UE” can utilize the proximity-based services, and supports the procedures in the proximity-based services as well as a specific capability for public safety. For example, the “ProSe-enabled Public Safety UE” transmits information for public safety through the proximity-based services. The information for public safety includes, for example, information on a disaster (such as an earthquake and a fire) and information used by a fire official or a police official.

The remote UE may be a UE that is located outside the network area (Out-of-Network). That is, the remote UE may be located outside a coverage of the cell. The remote UE may be located within the coverage of the cell. Therefore, the remote UE may be a UE 100 to which a service is not directly provided by the E-UTRAN 10 (UE 100 which is not served by the E-UTRAN 10). The remote UE is provided with a ProSe relay service from the relay UE, as described later. A relay is executed between the remote UE that is provided with the ProSe relay service and the relay UE that provides the ProSe relay service.

The relay UE (ProSe UE-to Network Relay) provides functions to support connectivity of “Unicast” services for the remote UE. Therefore, the relay UE provides the ProSe relay service for the remote UE. Therefore, the relay UE can relay data (unicast traffic) between the remote UE and the network. The relay UE can relay data (traffic) of the remote UE through the proximity-based services (direct communication). Specifically, the relay UE can relay data (uplink traffic) received from the remote UE via the PC5 interface to the eNB 200 via a Uu interface (LTE-Uu) or a Un interface (LTE-Un). The relay UE can relay data (downlink traffic) received from the eNB 200 via the Uu interface or the Un interface to the remote UE via the PC5 interface. The relay UE may be located only within the network (within the coverage of the cell).

The relay UE can provide a comprehensive function capable of relaying any type of traffic related to the communication for public safety.

The relay UE and the remote UE can transmit data and control information between the physical layers. Similarly, the relay UE and the remote UE can transmit data and control information between the MAC layers, between the RLC layers, and between the PDCP layers. In addition, the relay UE may have an IP-Relay layer as an upper layer of the PDCP layer. The remote UE may also have an IP layer as an upper layer of the PDCP layer. The relay UE and the remote UE can transmit data and control information between the IP-Relay layer and the IP layer. The relay UE is able to transmit data between the IP-Relay layer and the IP layer of a IP-GW 350.

In an AS layer (Access Stratum), the relay UE can transmit data (traffic) to the remote UE by broadcast. In the AS layer, the relay UE may transmit data to the remote UE by unicast. If the ProSec relay service is executed by broadcast, a feedback in the NAS layer (Non Access Stratum) may be performed between the relay UE and the remote UE, but a feedback in the AS layer is not performed. If the UE-to-Network relay is executed by unicast, the feedback in the AS layer may be performed.

(Control Plane Relay Protocol Stack)

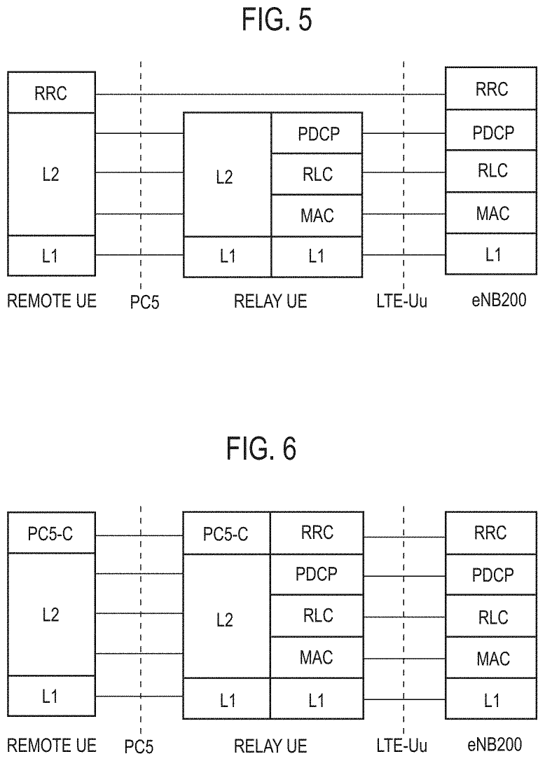

An example of the control plane protocol stack of the radio interface in the case where the relay is executed will be described with reference to FIG. 5 and FIG. 6. FIG. 5 and FIG. 6 are diagrams illustrating examples of a control plane relay protocol stack.

In the present embodiment, a connection can be established between the remote UE and the network for transmitting control information (control plane message) related to the relay UE.

For example, as illustrated in FIG. 5, when a relay UE relays data of a remote UE, an RRC message may be transmitted between the RRC layer of the remote UE and the RRC layer of the eNB. That is, an RRC connection may be established between the remote UE and the eNB 200. In this case, the RRC message passes through the relay UE. That is, the relay UE transmits the RRC message without recognizing the content of the RRC message. The RRC message contains control information in the RRC layer.

Specifically, the remote UE generates an RRC message. The remote UE sends the generated RRC message to the relay UE. The relay UE transmits the RRC message to the eNB 200 without change. Likewise, the relay UE transmits the RRC message received from the eNB 200 to the remote UE without any change.

As illustrated in FIG. 6, in the case where the relay UE relays the data of the remote UE, the remote UE and the relay UE may have a PC5-C layer on the upper layer of the L2 layer. The relay UE and the remote UE may transmit the PC5-C message corresponding to the RRC message between the PC5-C layers. The relay UE and the eNB 200 may have an RRC layer for relaying. Therefore, the RRC connection may terminate at the relay UE.

The remote UE generates a PC5-C message containing control information in the RRC layer. The remote UE transmits the generated PC5-C message to the relay UE. The relay UE generates an RRC message including control information based on the PC5-C message. The relay UE transmits the generated RRC message to the eNB 200. When receiving an RRC message to the remote UE from the eNB 200, the relay UE generates a PC5-C message including control information in the RRC message based on the RRC message. The relay UE transmits a PC5-C message to the relay UE. In this way, the relay UE may generate an RRC message on behalf of the remote UE.

(Radio Terminal)

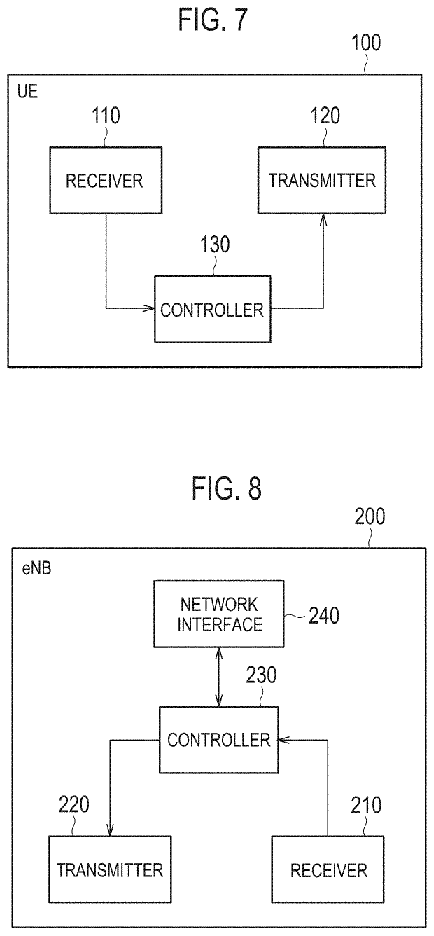

The UE 100 (radio terminal/wearable terminal) according to the embodiment will be described. FIG. 7 is a block diagram of the UE 100. As illustrated in FIG. 7, the UE 100 includes a receiver 110, a transmitter 120, and a controller 130. The receiver 110 and the transmitter 120 may be an integrated transceiver.

The receiver 110 performs various types of receptions under the control of the controller 130. The receiver 110 includes an antenna. The receiver 110 converts a radio signal received by the antenna into a baseband signal (reception signal). The receiver 110 outputs the baseband signal to the controller 130.

The transmitter 120 performs various types of transmissions under the control of the controller 130. The transmitter 120 includes an antenna. The transmitter 120 converts the baseband signal (transmission signal) output from the controller 130 into a radio signal. The transmitter 130 transmits the radio signal from the antenna.

The controller 130 performs various types of controls in the UE 100. The controller 130 includes a processor and a memory. The memory stores a program to be executed by the processor, and information to be used for a process by the processor. The processor includes a baseband processor and a CPU (Central Processing Unit). The baseband processor performs, for example, modulation and demodulation, and coding and decoding, of the baseband signal. The CPU executes a program stored in the memory to perform various types of processes. The processor may include a codec configured to perform encoding and decoding on sound and video signals. The processor executes various types of processes described later, and various types of communication protocols described above.

The UE 100 may include a GNSS (Global Navigation Satellite System) receiver unit. The GNSS receiver unit can receive a GNSS signal to obtain location information indicating a geographical location of the UE 100. The GNSS receiver unit outputs the GNSS signal to the controller 130. The UE 100 may have a GPS (Global Positioning System) function for acquiring location information of the UE 100.

For simplicity, a process executed by at least any one of the receiver 110, the transmitter 120, and the controller 130 included in the UE 100 is described herein as a process (operation) executed by the UE 100.

(Base Station)

The eNB 200 (base station) according to the embodiment will be described. FIG. 8 is a block diagram of the eNB 200. As illustrated in FIG. 8, the eNB 200 includes a receiver 210, a transmitter 220, a controller 230, and a network interface 240. The receiver 210 and the transmitter 220 may be an integrated transceiver.

The receiver 210 performs various types of receptions under the control of the controller 230. The receiver 210 includes an antenna. The receiver 210 converts a radio signal received by the antenna into a baseband signal (reception signal). The receiver 210 outputs the baseband signal to the controller 230.

The transmitter 220 performs various types of transmissions under the control of the controller 230. The transmitter 220 includes an antenna. The transmitter 220 converts the baseband signal (transmission signal) output from the controller 230 into a radio signal. The transmitter 220 transmits the radio signal by the antenna.

The controller 230 performs various types of controls in the eNB 200. The controller 230 includes a processor and a memory. The memory stores a program to be executed by the processor, and information to be used for a process by the processor. The processor includes a baseband processor and a CPU. The baseband processor performs, for example, modulation and demodulation, coding and decoding, and the like, of the baseband signal. The CPU executes a program stored in the memory to perform various types of processes. The processor executes various types of processes described later, and various types of communication protocols described above.

The network interface 240 is connected to a neighbour eNB 200 via the X2 interface. The network interface 240 is connected to the MME 300 and the SGW 400 via the S1 interface. The network interface 240 is used in communication performed on the X2 interface and communication performed on the S1 interface, for example. The network interface 240 is used for communication with the HSS 600.

For simplicity, a process executed by at least any one of the transmitter 210, the receiver 220, the controller 230, and the network interface 240 included in the eNB 200 is described herein as a process (operation) executed by the eNB 200.

(Operation According to Embodiment)

Next, an operation according to an embodiment will be described.

In a case where a relay UE is available, the remote UE is able to use the following paths.

The relay UE is the UE 100. As an example of the remote UE, wUE 150 which is a wearable UE will be described. It is needless to say that the remote UE may be a normal radio terminal (UE) instead of a wearable UE.

The UE 100 (including the receiver 110, the transmitter 120, and the controller 130) is able to execute cellular communication (transmission of an uplink signal and reception of a downlink signal) and a sidelink operation (transmission and/or reception of a sidelink signal). The sidelink signal may be at least one of a signal in direct communication and a signal in direct discovery. The sidelink signal may include a synchronization signal (SLSS: SidelinkSynchronizationSignal) for synchronization in the sidelink. The sidelink signal may be a PC5 signal used for a control plane signal on the PC5.

The wUE 150 (including the receiver 110, the transmitter 120, and the controller 130) may be used to execute the sidelink operation. The wUE 150 is able to execute reception of the downlink signal. The wUE 150 may or may not be able to execute the transmission of the uplink signal. Accordingly, the wUE 150 may not have the transmitter 120 for transmitting the uplink signal.

The wUE 150 is a wearable UE. That is, the wUE 150 is a communication device that a user may wear. Since the UE 100 and the wUE 150 are carried by the user, the UE 100 and the wUE 150 are in a short distance state. As the user moves, the UE 100 and the wUE 150 move together while maintaining the short distance state.

The wUE 150 may be a short distance device. The wUE 150 may be a communication device by which the sidelink operation is considered to be executed at a short distance (within a range of several meters (for example, 2 m)).

In the present specification, the “short distance” may be defined by a communicable distance (for example, a range of several meters). For example, a maximum reachable distance (maximum reachable range) of the sidelink signals between short distance devices (between a UE and a wUE/between a wUE and another wUE) is shorter than a maximum reachable distance of the sidelink signal between normal UEs (between a UE and another UE). It is needless to say that the maximum reachable distance of the sidelink signal between the short distance devices is shorter than the maximum reachable distance of the uplink signal between the UE and the eNB.

The “short distance” may be defined by (maximum) transmission power of the sidelink signal (for example, maximum transmission power is 0 dBm or less). For example, the maximum transmission power of the sidelink signal between short distance devices (between a UE and a wUE/between a wUE and another wUE) is lower than the maximum transmission power of the sidelink signal between normal UEs (between a UE and another UE). It is needless to say that the maximum transmission power of the sidelink signal between the short distance devices is lower than the maximum transmission power of the uplink signal between the UE and the eNB.

The “short distance” may be defined by a resource pool (condition/setting of the resource pool) available to the wUE 150.

The wUE 150 may not need to mount an existing Subscriber Identity Module Card (SIM), differently from the existing UE 100. The wUE 150 may be attachable to a short distance SIM (D2D SIM).

(A) Downlink Path

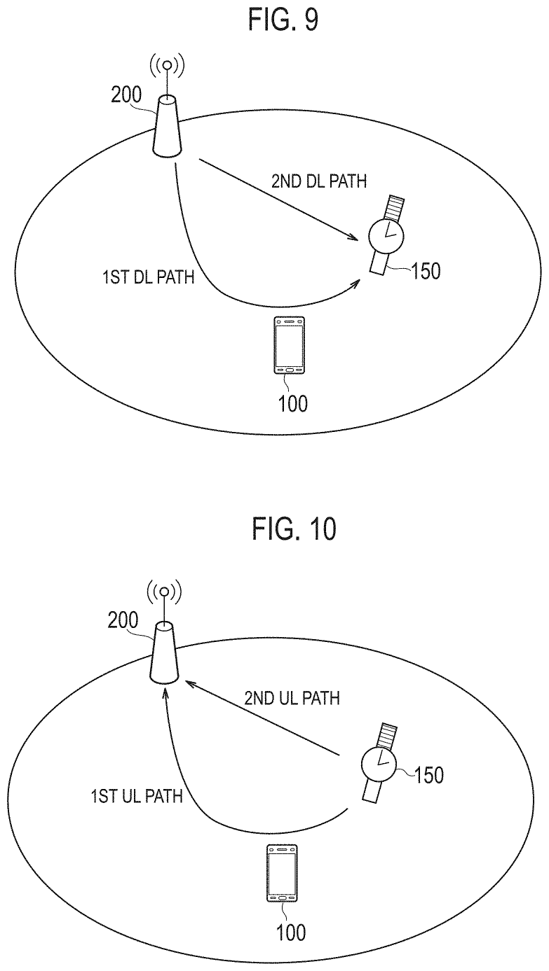

The downlink path will be described with reference to FIG. 9. FIG. 9 is a diagram for describing the downlink path.

As illustrated in FIG. 9, the UE 100 and the wUE 150 exists in a cell controlled by the eNB 200. The UE 100 and wUE 150 are located in the cell.

A first downlink path (1ST DL PATH) is a path ((DL-)SL) from the eNB 200 to the wUE 150 via the UE 100. The wUE 150 indirectly receives the downlink information from the eNB 200 via the UE 100. The UE 100 forwards (relays) the downlink information from the eNB 200 to the wUE 150 on, for example, a sidelink.

A second downlink path (2ND DL PATH) is a path ((DL-)Uu) from the eNB 200 to the wUE 150 not via the UE 100. The wUE 150 directly receives downlink information from the eNB 200 not via the UE 100.

The wUE 150 receives downlink information from the eNB 200 through the first downlink path and the second downlink path. The downlink information is user data and/or control information.

(B) Uplink Path

An uplink path will be described with reference to FIG. 10. FIG. 10 is a diagram for describing the uplink path.

The first uplink path (1ST UL PATH) is a path ((UL-)SL) from the wUE 150 to the eNB 200 via the UE 100. The wUE 150 indirectly transmits uplink information to the eNB 200 via the UE 100. The wUE 150 transmits the uplink information to the UE 100 by, for example, a sidelink.

A second uplink path (2ND UL PATH) is a path ((UL-)Uu) from the wUE 150 to the eNB 200 not via the UE 100. The wUE 150 directly transmits the uplink information to the eNB 200 not via the UE 100.

The wUE 150 transmits the uplink information to the eNB 200 through the first uplink path and the second uplink path. The uplink information is user data and/or control information.

### (1) OPERATION EXAMPLE 1

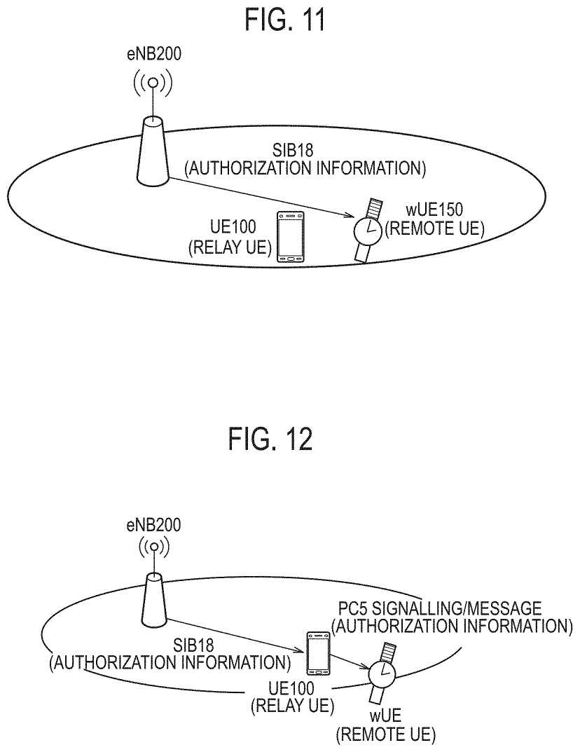

The operation example 1 will be described with reference to FIG. 11. FIG. 11 is a diagram for describing the operation example 1.

As illustrated in FIG. 11, the eNB 200 transmits authorization information indicating that it is possible to establish a predetermined connection via the relay UE.

The eNB 200 may transmit the authorization information to the wUE 150 by dedicated signaling (such as RRC reconfiguration message and Downlink Control Information (DCI), for example) and/or broadcast signaling (for example, System Information Block (SIB)). For example, the eNB 200 may broadcast the authorization information in the SIB18. The eNB 200 may determine whether or not to transmit authorization information in response to a request from the wUE 150.

The authorization information may be information indicating that control information (Control Plane (CP) message) in an RRC layer is able to be transmitted via the relay UE. The authorization information may be information applicable only to the In Coverage UE (UE) located in-coverage of a cell. The authorization information may be applied to the UE located in an extended coverage. The authorization information may be information not applicable to Out Of Coverage UE (UE) located out-of-coverage of a cell. The wUE 150 located in-coverage of a cell (extended coverage) may establish an RRC connection directly with the eNB 200. Therefore, the eNB 200 is able to appropriately control the wUE 150 by explicitly indicating establishment of a predetermined connection via the relay UE.

The authorization information may be included in relay setting information using the proximity service.

The predetermined connection is a connection used to transmit control information in the RRC layer. For example, the predetermined connection is an RRC connection between the remote UE and the eNB 200 (see FIG. 5). The predetermined connection may be a connection including a PC5-C connection between the remote UE and the relay UE and the RRC connection between the relay UE and the eNB 200 (see FIG. 6).

The wUE 150 receives the authorization information from the eNB 200. In response to receiving the authorization information, the wUE 150 starts control to establish a predetermined connection. Only in a case where the wUE 150 has received the authorization information, the wUE 150 may initiate control to establish a predetermined connection. In a case where the wUE 150 does not receive the authorization information, the wUE 150 may determine that a predetermined connection is unable to be established.

The eNB 200 may send unauthorization information indicating that control information in the RRC layer is unable to be transmitted via the relay UE. In a case where the wUE 150 has received the unauthorization information, the wUE 150 may determine that a predetermined connection is unable to be established. In a case where the wUE 150 does not receive unauthorization information, the wUE 150 may determine that a predetermined connection is able to be established.

As described above, the wUE 150 and the eNB 200 are able to transmit control information in the RRC layer between the wUE 150 and the eNB 200, by a predetermined connection through the UE 100. In this way, the control information is able to be transmitted more robustly.

In a case where the RRC connection is established between the wUE 150 and the eNB 200, the wUE 150 performs location registration on the network (Attach). Therefore, it is possible to easily implement transmission of data (traffic) to the wUE 150 (Remote UE terminated service). It is possible to easily implement management for charging the wUE 150.

### (2) OPERATION EXAMPLE 2

The operation example 2 will be described with reference to FIG. 12. FIG. 12 is a diagram for describing operation example 2. The description of parts similar to those described above will not be repeated.

In the operation example 2, the wUE 150 receives authorization information from the UE 100.

As illustrated in FIG. 12, the eNB 200 transmits the authorization information. The UE 100 receives the authorization information. Based on the authorization information (or unauthorization information), the UE 100 is able to recognize whether or not the eNB 200 permits establishment of a predetermined connection.

The UE 100 is able to transmit, to the wUE 150, information (authorization information/unauthorization information) indicating whether or not the eNB 200 permits establishment of a predetermined connection. For example, the UE 100 is able to perform transmission to the wUE 150, by a direct radio signal (sidelink signal) in the ProSe.

For example, the sidelink signal may be at least one of a MasterinformationBlock-SL (MIB-SL) signal, a synchronization signal (Primary Sidelink Synchronisation Signal (PSSS)/Secondary Sidelink Synchronisation Signal (SSSS)), a Discovery signal, and a Discovery signal for Relay. In a case where the UE 100 has received, from the wUE 150, an inquiry as to whether or not it is possible to establish a predetermined connection, the UE 100 may transmit authorization information/unauthorization information to the wUE 150. In a case where the UE 100 has received the inquiry from the wUE 150, the UE 100 may transmit, to the eNB 200, the inquiry as to whether it is possible to establish a predetermined connection. In response to the inquiry from the UE 100, the eNB 200 may (individually) transmits authorization information/unauthorization information to the UE 100.

The sidelink signal may be an acknowledgment message (Direct Communication Accept) in response to a message (Direct Communication Request) for establishing a direct link between the UE 100 and the wUE 150. In a case where the Direct Communication Request includes information indicating an inquiry as to whether or not it is possible to establish a predetermined connection, the UE 100 may transmit authorization information/unauthorization information to the wUE 150.

The sidelink signal may include authorization information/unauthorization information. A sequence (signal sequence) of the sidelink signals may indicate authorization information/unauthorization information.

The wUE 150 is able to determine whether or not it is possible to establish a predetermined connection, based on the authorization information/unauthorization information.

The authorization information may be information indicating that the UE 100 is able to relay control information in the RRC layer. The unauthorization information may be information indicating that the UE 100 is unable to relay the control information in the RRC layer.

### (3) OPERATION EXAMPLE 3

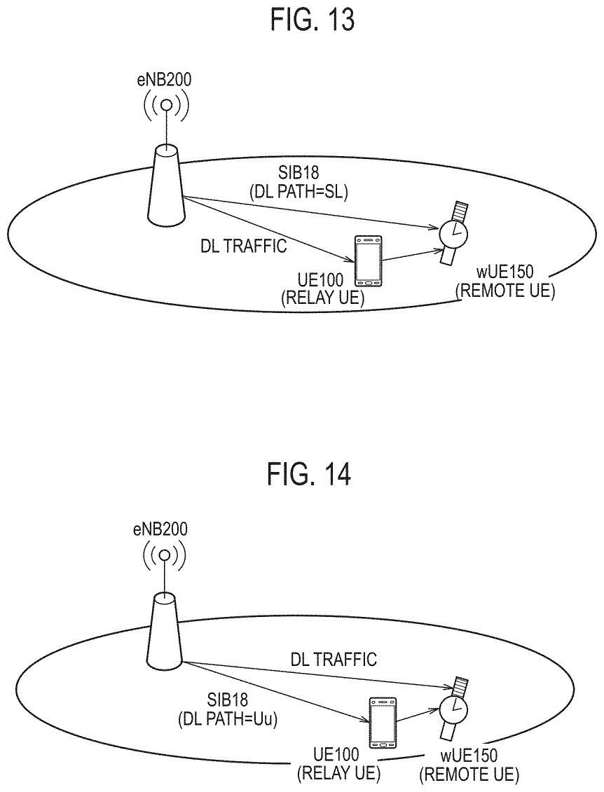

The operation example 3 will be described with reference to FIGS. 13 and 14. FIGS. 13 and 14 are diagrams for describing the operation example 3. The description of parts similar to those described above will not be repeated.

In the operation example 3, the eNB 200 transmits first specification information specifying a downlink path.

As illustrated in FIGS. 13 and 14, the eNB 200 transmits the first specification information specifying the downlink path. The eNB 200 may transmit the first specification information by broadcast signaling or dedicated signaling. For example, the eNB 200 may transmit the first specification information by the following method.

Firstly, the eNB 200 is able to transmit the first specification information in the System Information Block (SIB). In this way, it is possible to notify all the UEs 100 (wUE 150) in the cell managed by the eNB 200, of the first specification information. At the time of establishing the RRC connection with the eNB 200, the UE 100 (wUE 150) is able to recognize a downlink path to be used.

Secondly, the eNB 200 may transmit the first specification information in an RRC connection reconfiguration message. In this way, it is possible to set the downlink path for each UE. It is possible to set the downlink path for each bearer.

Thirdly, the eNB 200 is able to transmit the first specification information by the MAC Control Element (MAC CE). In this way, it is possible to dynamically set the downlink path for each UE.

Fourthly, the eNB 200 is able to transmit the first specification information in Downlink Control Information (DCI). In this way, it is possible to set the downlink path for each downlink transmission.

The eNB 200 may indirectly transmit the first specification information to the wUE 150 through the UE 100 (see FIG. 13). In a case where the UE 100 has received the first specification information, the UE 100 may transmit (forward) the first specification information to the wUE 150. The eNB 200 may transmit the first specification information directly to the wUE 150 (see FIG. 14).

Only in a case where the eNB 200 transmits authorization information described above, the eNB 200 may transmit the first specification information. The eNB 200 may transmit the first specification information together with the authorization information.

The first specification information indicates a first downlink path (SL) or a second downlink path (Uu) as a downlink path. The first specification information may be information indicating that the first downlink path (SL) is valid (activation)/invalid (deactivation). The first specification information may be information indicating that the second downlink path (Uu) is valid (activation)/invalid (deactivation).

The eNB 200 may select (determine) a downlink path by at least one of the following methods. The eNB 200 transmits the first specification information indicating the selected downlink path.

Firstly, the eNB 200 selects a downlink path according to the radio conditions of the wUE 150.

For example, in a case where the received level (for example, received intensity (Reference Signal Receive Power (RSRP))/received quality (Reference Signal Received Quality (RSRQ)) of a radio signal (for example, a reference signal) from the eNB 200 in the wUE 150 is less than a threshold value, the eNB 200 may select the first downlink path (SL). In a case where the received level is equal to or more than the threshold value, the eNB 200 may select the second downlink path (Uu). The eNB 200 is able to select the downlink path based on a measurement report for the wUE 150. The wUE 150 is able to notify the eNB 200 of the measurement report via (or not via) the UE 100. The eNB 200 may regard a measurement report for the UE 100 as the measurement report for the wUE 150.

In a case where the wUE 150 exists in the extended coverage, the eNB 200 may select the first downlink path (SL). In a case where the wUE 150 exists in normal coverage, the second downlink path (Uu) may be selected. The eNB 200 is able to select the downlink path based on a report related to the extended coverage from the wUE 150. The report related to the extended coverage includes information indicating whether or not the wUE 150 exists in the extended coverage. The wUE 150 may notify the eNB 200 of a report related to the extended coverage via (or not via) the UE 100. The eNB 200 may regard a report related to the extended coverage for the UE 100 as the report related to the extended coverage for the wUE 150.

In a case where the received level of the radio signal (reference signal) from the eNB 200 is less than a threshold value indicating a boundary of the normal coverage and is equal to or more than another threshold value indicating the boundary of the extended coverage, the wUE 150 is able to determine that the wUE 150 exists in the extended coverage.

Secondly, the eNB 200 selects a downlink path in response to a request from the wUE 150 and/or the UE 100.

The wUE 150 and/or the UE 100 may make a request to the eNB 200 for the desired downlink path. The wUE 150 may notify the eNB 200 of the request via (or not via) the UE 100.

Similarly to the eNB 200, the wUE 150 and/or the UE 100 may determine the desired downlink path based on the received level of the radio signal from the eNB 200 in the wUE 150. The wUE 150 and/or the UE 100 may determine the desired downlink path depending on whether or not the wUE 150 exists in the extended coverage. The UE 100 may regard a received level of the radio signal from the eNB 200 in the UE 100 as the received level of the radio signal from the eNB 200 in the wUE 150.

The wUE 150 and/or the UE 100 may receive, from the eNB 200, a threshold value that is used to determine the downlink path.

The wUE 150 and/or the UE 100 may notify the eNB 200 of the desired downlink path by MAC CE, UE Assiance Information, SidelinkUEInformation or the like.

The eNB 200 may select a downlink path based on the desired downlink paths received from the wUE 150 and/or the UE 100.

Thirdly, the eNB 200 selects a downlink path depending on the load situation of the eNB 200.

For example, the eNB 200 may select the second downlink path (Uu), in a case where the load of the eNB 200 is less than the threshold value. The first downlink path (SL) may be selected, in a case where the load of the eNB 200 is equal to or larger than the threshold value. In a case where the UE 100 forwards the downlink information according to the mode 2, the UE 100 autonomously selects a radio resource from a terminal-to-terminal communication (relay) resource pool, so that the radio resource needs not to be allocated to the wUE 150. Therefore, it is possible to reduce the load on the eNB 200.

The load on the eNB 200 is, for example, a quantity of downlink resource (in use).

Fourthly, the eNB 200 selects a downlink path depending on an interference situation.

For example, the eNB 200 may select the second downlink path (Uu), in the case of interfering with other radio devices, based on the interference information received from the adjacent eNB 200. The eNB 200 may select the first downlink path (SL), in the case of interfering with other radio devices. The eNB 200 is able to skip transmission of the downlink information directly to the wUE 150. Therefore, in a case where it is possible to reduce the downlink transmission power by skipping the transmission of the downlink information, the eNB 200 is able to reduce interfering with other radio devices.

The wUE 150 receives the downlink information from the eNB 200 through the first downlink path (SL) or the second downlink path (Uu), based on the first specification information. For example, in a case where the eNB 200 has specified the first downlink path (SL), the eNB 200 transmits the downlink information (DL traffic) to the wUE 150 through the first downlink path (see FIG. 13). In a case where the eNB 200 has specified the second downlink path (Uu), the eNB 200 transmits the downlink information to the wUE 150 through the second downlink path (see FIG. 14).

The eNB 200 may replace the downlink path according to the change of the situation described above. In a case where the eNB 200 replaces the downlink path, the eNB 200 is able to transmit the first specification information.

### (4) OPERATION EXAMPLE 4

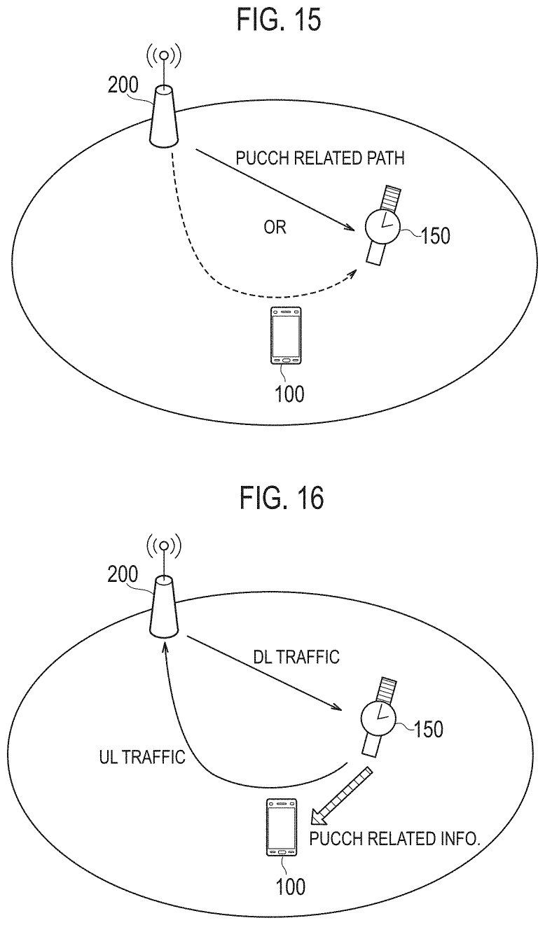

The operation example 4 will be described with reference to FIGS. 15 to 17. FIGS. 15 to 17 are diagrams for describing the operation example 4. The description of parts similar to those described above will not be repeated.

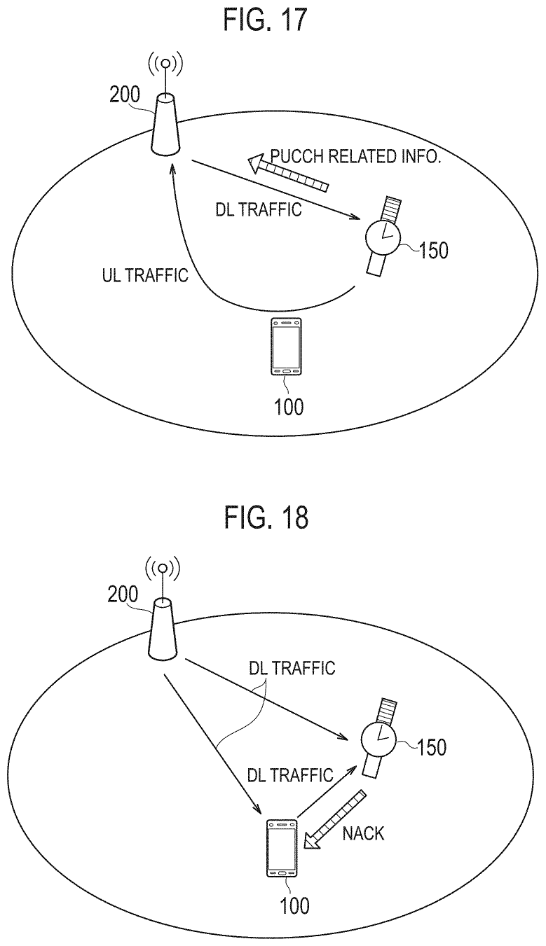

In the operation example 4, in principle, the uplink information is transmitted through the first uplink path (UL-SL). The downlink information is transmitted through the second downlink path (DL-Uu) (see FIGS. 16 and 17).

As illustrated in FIG. 15, the eNB 200 transmits the second specification information. The eNB 200 transmits the second specification information, similarly to the first specification information described above. The eNB 200 may transmit the second specification information directly to the wUE 150. The eNB 200 may indirectly transmit the second specification information to the wUE 150 through the UE 100. In a case where the UE 100 has received the second specification information, the UE 100 may transmit (forward) the second specification information to the wUE 150.

The second specification information specifies a path on which PUCCH related information is to be transmitted. The second specification information specifies a first uplink path (SL) or a second uplink path (Uu) as a path on which the PUCCH related information is to be transmitted.

The PUCCH related information (PUCCH RELATED INFO.) is information (control information) to be transmitted on the physical uplink control channel (PUCCH). For example, the PUCCH related information includes at least one of acknowledgment information (ACKNOWLEDGEMENT (ACK)/Negative ACKNOWLEDGEMENT (NACK)) in response to the downlink information; channel state information (CSI); and a scheduling request (SR).

The acknowledgment information is, for example, Hybrid ARQ (HARQ) ACK/NACK.

The channel state information may include a Precoding Matrix Indicator (PMI) a Rank Indicator (RI), and a Channel Quality Indicator (CQI). The CQI indicates a modulation and coding scheme (that is, a recommended MCS) preferable for use in the downlink based on the received state of the downlink. The PMI is information indicating a precoder matrix preferable for use in the downlink. In other words, the PMI is information indicating the precoder matrix to which the beam is directed to the UE as the source of the PMI. The RI illustrates a preferable rank for use in the downlink.

The scheduling request is information for making a request for the radio resource to the eNB 200.

The wUE 150 transmits the PUCCH related information based on the second specification information. In a case where the first uplink path (SL) is specified, the wUE 150 transmits the PUCCH related information to the UE 100 through the first uplink path (see FIG. 16). In a case where the UE 100 has received the PUCCH related information, the UE 100 may transmit the PUCCH related information to the eNB 200.

The wUE 150 may transmit the PUCCH related information to the UE 100, for example, by the MAC CE. The UE 100 may transmit the PUCCH related information to the eNB 200, by MAC CE. The wUE 150 may transmit the PUCCH related information to the UE 100 in an RRC message (or a PC5-C message). The wUE 150 may transmit, to the UE 100, the PUCCH related information together with information (for example, a measurement report) to be transmitted to the other eNBs 200. The UE 100 may transmit the RRC message to the eNB 200 without changing. The UE 100 may generate an RRC message including the PUCCH related information and the like based on the PC5-C message. The UE 100 may transmit the generated RRC message to the eNB 200.

In a case where the second uplink path (Uu) is specified, the wUE 150 transmits the PUCCH related information to the eNB 200 through the second uplink path (see FIG. 17). That is, the wUE 150 transmits the PUCCH related information to the eNB 200 on the PUCCH. On the other hand, the wUE 150 transmits uplink information (for example, data (UL TRAFFIC)) excluding the PUCCH related information, to the UE 100 through the first uplink path.

In a case where the wUE 150 does not receive specification information, the wUE 150 may transmit the PUCCH related information, to the UE 100 through the first uplink path (SL) on which the uplink information is transmitted. Since the PUCCH related information is to be transmitted on the PUCCH, the wUE 150 may transmit the PUCCH related information, to the UE 100 through the second uplink path (Uu), in a case where the wUE 150 has not received specification information.

As described above, the eNB 200 is able to transmit the second specification information specifying a path on which the PUCCH related information is to be transmitted. Even though the first uplink path (UL-SL) and the second downlink path (DL-Uu) are used, the eNB 200 is able to flexibly set a path on which the PUCCH related information is to be transmitted. By specifying the second uplink path (Uu), the eNB 200 is able to suppress the occurrence of a delay caused by via the relay UE.

### (5) OPERATION EXAMPLE 5

The operation example 5 will be described with reference to FIG. 18. FIG. 18 is a diagram for describing the operation example 5. The description of parts similar to those described above will not be repeated.

The operation example 5 is a case where the PUCCH related information is acknowledgment information (ACK/NACK).

As illustrated in FIG. 18, the eNB 200 transmits downlink information (DL TRAFFIC). The wUE 150 attempts to receive the downlink information addressed to the wUE 150. The eNB 200 assigns a Cell-Radio Network Temporary Identifier (C-RNTI) to the wUE 150. The C-RNTI is an identifier for acquiring downlink information from the eNB 200. The eNB 200 is able to encode the downlink information addressed to the wUE 150, by using the C-RNTI assigned to the wUE 150. The eNB 200 transmits the encoded downlink information.

The wUE 150 attempts to decode the received downlink information, by using the Cell-Radio Network Temporary Identifier (C-RNTI) assigned to the eNB 200.

The UE 100 receives the C-RNTI from the eNB 200 or the wUE 150. The C-RNTI is the same as the C-RNTI held by the wUE 150. The C-RNTI may be included in the relay setting information. The eNB 200 may set (or may assign), to the UE 100, the same C-RNTI as the C-RNTI of the wUE 150. The UE 100 may receive the C-RNTI from the eNB 200 or the wUE 150, when establishing a relay connection.

The UE 100 attempts to receive the downlink information addressed to the wUE 150, by using the C-RNTI. In a case where the UE 100 receives acknowledgment information in response to the downlink information, or in a case where the UE 100 executes retransmission in response to the NACK, the UE 100 may attempt to receive downlink information addressed to the wUE 150. Specifically, the UE 100 attempts to decode the received downlink information, by using the C-RNTI. The UE 100 acquires the downlink information by successfully decoding the downlink information. The UE 100 may acquire the downlink information by using the C-RNTI for the wUE 150, regardless of the downlink information addressed to the UE 100 itself.

In a case where the wUE 150 has failed to receive or decode the downlink information, the wUE 150 transmits, to the UE 100, negative information (NACK) as acknowledgment information. The wUE 150 may transmit the NACK together with an identifier (for example, a DL process ID) indicating the downlink information which the wUE 150 has failed to receive. The wUE 150 may include an identifier for retransmission using a MAC header or a MAC CE.

Instead of the eNB 200, the UE 100 may transmit (retransmit) the downlink information, in response to acknowledgment information being the NACK. The UE 100 may transmit the downlink information by sidelink. The “retransmission” is retransmission to the wUE 150. The UE 100 may transmit the downlink information at the initial transmission.

The UE 100 may specify downlink information to be transmitted, based on an identifier indicating downlink information from the wUE 150. In a case where the UE 100 transmits downlink information, the UE 100 may include information indicating retransmission in response to the NACK. The UE 100 may transmit downlink information together with the same identifier as the identifier for retransmission received from the wUE 150. The UE 100 may transmit, to the wUE 150, the identifier, by using a Sidelink Control Information (SCI), a MAC header, a MAC CE, or the like.

In a case where DL MIMO (Multiple-Input and Multiple-Output) is being executed, the UE 100 may transmit, to the wUE 150, each downlink information (DL TRAFFIC) of multiplexed downlink information. That is, the UE 100 may associate a different logical channel ID (LCID) with each downlink information. The UE 100 may transmit each downlink information to the wUE 150, by using each LCID.

The eNB 200 may transmit, to the UE 100, setting information for retransmission. The setting information may include a setting value at which a retransmitted packet is not segmented in an RLC layer. The setting value may be at least one of a Transport Block Size (TB S), an MCS, and a Resource Brock (RB). In a case where the UE 100 is able to select the setting value (mode 2 transmission), the UE 100 may select a setting value at which the retransmission packet is not segmented in the RLC layer. In this way, since the retransmitted packet is not segmented in the RLC layer, it is possible to reduce the processing load of the UE 100.

The UE 100 may repetitively transmit the downlink information as the retransmission of the downlink information. For example, the UE 100 may perform four repeated transmissions. In repeated transmissions, the same downlink information is transmitted. The UE 100 may perform retransmission by the HARQ processing. In the retransmission by the HARQ processing, for example, the same downlink information may not be transmitted due to the load of redundant bits or the like.

In a case where the UE 100 transmits (retransmits) the downlink information, the UE 100 may use an RV value (an RV value used for the second transmission) following a Redundancy Version (RV) value used for the downlink information transmitted from the eNB 200. The UE 100 may transmit the downlink information by using a new RV value. The new RV value may be a value unrelated to the RV value (the RV value used for the first transmission) used for transmission of the downlink information. The UE 100 may autonomously select a predetermined value to be used as the new RV value. For example, the UE 100 may select a predetermined value predefined according to the specification as the new RV value. The UE 100 may be notified of the predetermined value from the eNB 200. For example, the eNB 200 may set, to the UE 100, a predetermined value according to setting information.

The wUE 150 receives the downlink information transmitted (retransmitted) from the UE 100. The wUE 150 may further transmit, to the UE 100, the acknowledgment information in response to the downlink information from the UE 100, similarly to those described above. The wUE 150 may further transmit the NACK, in a case where the wUE 150 has failed to receive the downlink information from the UE 100. In a case where the downlink information is retransmitted by repeated transmissions on the sidelink, the UE 100 may not transmit the acknowledgment information, regardless of the success/failure of the reception of the downlink information.

In a case where the UE 100 has received the NACK, the UE 100 may further execute the transmission (retransmission) of the downlink information. The UE 100 may forward the NACK to the eNB 200 without executing retransmission.

In a case where the eNB 200 has received the NACK from the UE 100, the eNB 200 may execute the retransmission of the downlink information through the second downlink path (Uu).

In a case where the eNB 200 has received the ACK from the UE 100, the eNB 200 may execute a process of discarding the packet corresponding to the transmitted downlink information (in the RLC layer/MAC layer). In a case where the eNB 200 is aware of the retransmission by the UE 100, the eNB 200 may regard the downlink information as that of transmission success. That is, the eNB 200 may execute a process of discarding the packet corresponding to the downlink information without receiving acknowledgment information. The eNB 200 may be aware of the UE 100 executing retransmission, according to the setting (information) for the UE 100 and/or the wUE 150. The UE 100 may notify the eNB 200 of the retransmission by the UE 100. The UE 100 may notify the eNB 200 of the reception success of the downlink information. The eNB 200 may be aware of retransmission by the UE 100, according to a notification from the UE 100.

As described above, instead of the eNB 200, the UE 100 performs the retransmission of the downlink information, so that it is possible to reduce the load on the eNB 200. In a case where the wUE 150 exists in the extended coverage, the eNB 200 has to perform repeated transmissions (Repetition). In such a case, since it is possible to save radio resources, it is possible to improve frequency utilization efficiency.

### (6) OPERATION EXAMPLE 6

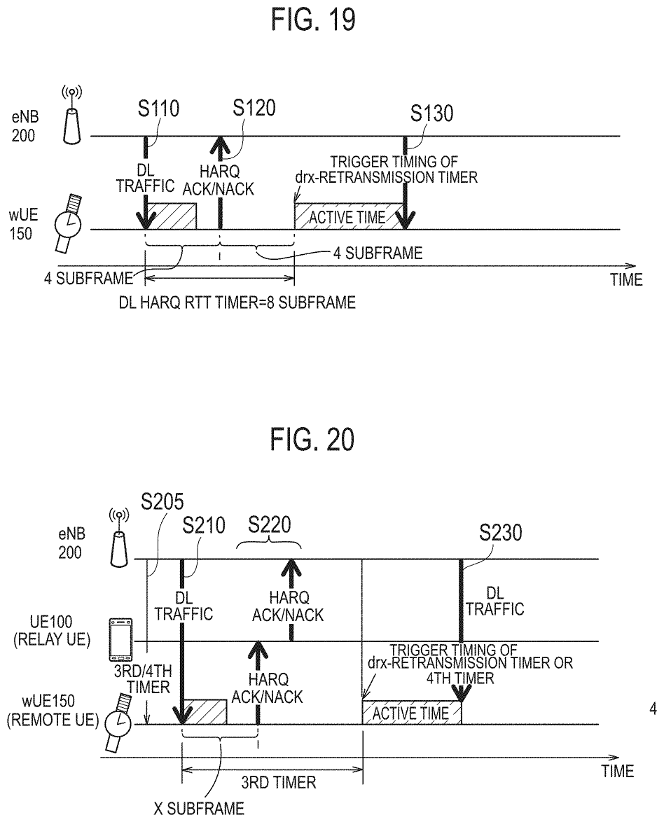

The operation example 6 will be described with reference to FIGS. 19 and 20. FIGS. 19 and 20 are diagrams for describing the operation example 6. The description of parts similar to those described above will not be repeated.

The operation example 6 is a case where the PUCCH related information is acknowledgment information (ACK/NACK), similarly to the operation example 5. The operation example 6 may be applied to a case where the wUE 150 is performing a DRX operation.

There will be described a case where the acknowledgment information (ACK/NACK) is transmitted on the second uplink path (Uu), with reference to FIG. 19.

As illustrated in FIG. 19, in step S110, the eNB 200 transmits downlink information (DL traffic) to the wUE 150.

In step S120, the wUE 150 transmits acknowledgment information (HARQ ACK/NACK) to the eNB 200. For example, the wUE 150 transmits acknowledgment information, after four sub-frames from the time of receiving the downlink information from the eNB 200.

In a case where the eNB 200 receives the acknowledgment information from the wUE 150 through the second uplink path (Uu), the eNB 200 may expect that the acknowledgment information will be received until a predetermined period from the time of transmitting the downlink information elapses. For example, the eNB 200 may expect that the acknowledgment information will be received until a predetermined period (4 sub-frames +a (propagation delay time)) elapses. The eNB 200 receives the acknowledgment information from the wUE 150.

In a case where the eNB 200 has not received the acknowledgment information within the predetermined period, the eNB 200 may start processing downlink information that has been transmitted in the RLC layer/MAC layer. For example, the eNB 200 may start HARQ retransmission processing. The eNB 200 may start discarding (flushing) the packet/DL process ID.

In a case where the eNB 200 has received the NACK or the eNB 200 does not receive the ACK, the eNB 200 executes a process of step S130.

In response to the reception of the downlink information, the wUE 150 activates a first timer (DL HARQ Round Trip Time (RTT) timer). The first timer is a timer for measuring a minimum quantity of sub-frames before the DL HARQ retransmission by a MAC entity is expected. That is, the first timer is a timer for measuring a period during which the eNB 200 does not start retransmission. For example, the first timer expires after the elapse of eight sub-frames. The wUE 150 set for the DRX may not monitor downlink information (for example, PDCCH) from the eNB 200 until the expiration of the first timer.

In response to the expiration of the first timer, the wUE 150 starts monitoring the downlink information (for example, PDCCH). The wUE 150 activates a second timer (drx-RetransmissionTimer) according to the start of the monitoring. The second timer is a timer for measuring a maximum quantity of consecutive PDCCH sub-frames until the reception of DL retransmission. That is, the second timer is a timer for measuring a period (Active Time) during which the UE 100 (MAC entity) continuously performs monitoring until the reception of the downlink information.

In step S130, the eNB 200 retransmits the downlink information. The eNB 200 may retransmit the downlink information in a period (Active Time) during which the UE 100 performs monitoring. By setting the first timer and the second timer for the UE 100, the eNB 200 may recognize a period during which the UE 100 executes monitoring.

Next, there will be described a case where the acknowledgment information (ACK/NACK) is transmitted on the first uplink path (SL), with reference to FIG. 20.

In step S205, the eNB 200 may notify the wUE 150 of information on a third timer (3RD timer). The eNB 200 may notify the wUE 150 of information on a fourth timer (4TH timer). The eNB 200 may notify the wUE 150 of the information on the third timer, similarly to the first specification information described above.

The third timer may be information for measuring the reception period of the acknowledgment information in the eNB 200. The third timer may be a timer for measuring a period during which the eNB 200 does not start retransmission for the wUE 150 transmitting the acknowledgment information on the first uplink path (SL). The third timer may be a timer serving as a trigger for starting the activation of the second timer or the fourth timer. The eNB 200 may notify the wUE 150 of the reception period of the acknowledgment information in the eNB 200, according to the information on the third timer. The eNB 200 may notify the wUE 150 of the reception period (information specifying the reception period) of the acknowledgment information in the eNB 200. The third timer (reception period) has a period longer than the first timer (predetermined period) until the expiration.

The fourth timer is a timer for measuring a period (Active Time) during which the wUE 150 continuously performs monitoring until the wUE 150 transmitting the acknowledgment information on the first uplink path (SL) will receive the downlink information. The fourth timer has a period longer than the second timer until the expiration.

Step S210 corresponds to step S110.

In step S220, the wUE 150 transmits acknowledgment information to the UE 100 through the first uplink path. The wUE 150 may transmit the acknowledgment information to the UE 100 on, for example, the sidelink, after x sub-frames from the time of receiving the downlink information from the eNB 200. The x may be less than four. The x may be more than four. The UE 100 transmits (forwards/relays) the acknowledgment information to the eNB 200. The UE 100 may transmit, to the eNB 200, the acknowledgment information from the wUE 150 in preference to other information to be transmitted to the eNB 200. In this way, it possible to reduce a transmission delay of the acknowledgment information based on a relay. As a result, it is possible to increase the possibility that the eNB 200 is able to retransmit the downlink information before the expiration of the Active Time in the wUE 150.

The other information may be, for example, other PUCCH related information (channel state information and scheduling request). The other information may be user data to be forwarded (relayed) from the wUE 150 to the eNB 200. The other information may be user data of the UE 100.

The wUE 150 may not monitor downlink information (for example, PDCCH) from the eNB 200 until the expiration of the third timer.

In response to the expiration of the third timer, the wUE 150 starts monitoring the downlink information (for example, PDCCH). The wUE 150 may activate the second timer (drx-RetransmissionTimer) or the fourth timer according to the start of the monitoring. In a case where the wUE 150 has transmitted the NACK, the wUE 150 may continue to monitor the downlink information until the reception of the downlink information even though the second timer and the fourth timer expire. That is, the wUE 150 may maintain the Active Time (DRX in-active state).

The wUE 150 may transmit, to the UE 100, information indicating transmission timing of acknowledgment information together with the acknowledgment information. The UE 100 may transmit, to the eNB 200, information indicating the transmission timing. The UE 100 may transmit, to the eNB 200, the information indicating reception timing of the acknowledgment information together with the acknowledgment information. The eNB 200 is able to recognize a delay caused by a relay based on the information indicating the transmission timing and/or the information indicating the reception timing. Based on the delay, the eNB 200 may determine whether or not to change a path on which the PUCCH related information is to be transmitted. In a case where the fourth timer is activated at the transmission timing of the acknowledgment information of the UE 100, the eNB 200 is able to estimate activation time of the fourth timer based on the information indicating the transmission timing and/or the information indicating the reception timing.

Even though the eNB 200 may not receive the acknowledgment information of the wUE 150 until the predetermined period (for example, 4 sub-frames+α (propagation delay time)) described above elapses, the eNB 200 may continue to hold the downlink information (packet)/DL process ID without discarding (flushing) downlink information (packet)/DL process ID. The eNB 200 may continue to hold the downlink information (packet)/DL process ID until the reception of the acknowledgment information.

In a case where the eNB 200 has received the NACK, the eNB 200 may start the retransmission of the downlink information. The eNB 200 may start the retransmission of the downlink information, in response that the eNB 200 is unable to receive the acknowledgment information even after the reception period has elapsed.

In step S230, the eNB 200 retransmits the downlink information. The eNB 200 may retransmit the downlink information in a period (Active Time) during which the UE 100 performs monitoring. By setting the third timer and the fourth timer (or the second timer) for the UE 100, the eNB 200 may recognize a period during which the UE 100 performs monitoring.

As described above, the eNB 200 is able to appropriately execute the retransmission control even though the reception timing of the acknowledgment information becomes later than four sub-frames.

### (7) OPERATION EXAMPLE 7

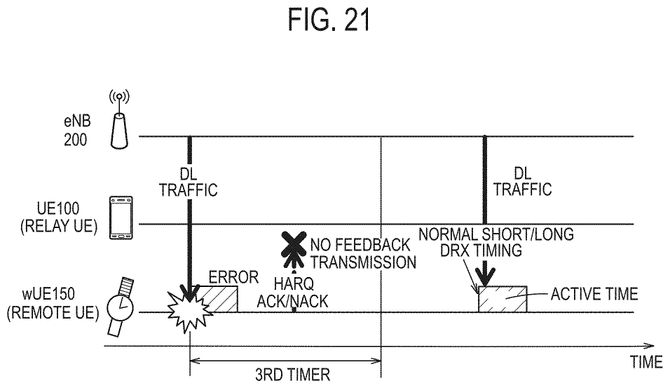

The operation example 7 will be described with reference to FIG. 21. FIG. 21 is a diagram for describing the operation example 7. The description of parts similar to those described above will not be repeated.

The operation example 7 is a case where the PUCCH related information is acknowledgment information (ACK/NACK), similarly to the operation example 6. In the operation example 7, there will be described a case where the wUE 150 is not aware of the transmission of the downlink information.

As illustrated in FIG. 21, in a case where the wUE 150 has failed to receive the DCI from the eNB 200, the wUE 150 is unable to recognize that the downlink information is being transmitted from the eNB 200. Therefore, the wUE 150 does not perform an operation of transmitting the acknowledgment information to the UE 100 (the eNB 200) (No feedback transmission).

Therefore, the eNB 200 may not calculate retransmission timing according to a monitoring period (Active Time) of the wUE 150, based on at least one of the first timer to the fourth timer described above. The eNB 200 may calculate the retransmission timing according to a DRX cycle (short/long DRX cycle). The DRX cycle specifies a periodic repetition of the monitoring period (Active Time/On Duration) following a period during which the wUE 150 is exempted from the monitoring of the PDCCH (a period during which inactivity is enabled).

The eNB 200 may calculate the retransmission timing based on the DRX cycle set for the wUE 150, in response that the eNB 200 has not received the acknowledgment information. The eNB 200 may calculate the monitoring period of the wUE 150 based on the DRX cycle. The eNB 200 may retransmit the downlink information based on the calculated retransmission timing. The eNB 200 is able to retransmit the downlink information within the monitoring period.

In a case where the wUE 150 transmits the acknowledgment information (ACK/NACK) on the first uplink path (SL), the wUE 150 may not calculate the monitoring period (Active Time) based on a second timer (drx-RetransmissionTimer) in order to receive the downlink information (retransmission of the downlink information). The wUE 150 may monitor the downlink information (retransmission of the downlink information) based on the monitoring period according to the DRX cycle.

As described above, even though the wUE 150 has failed to receive the DCI from the eNB 200, the wUE 150 is able to receive the downlink information (retransmission of the downlink information).

### (8) OPERATION EXAMPLE 8

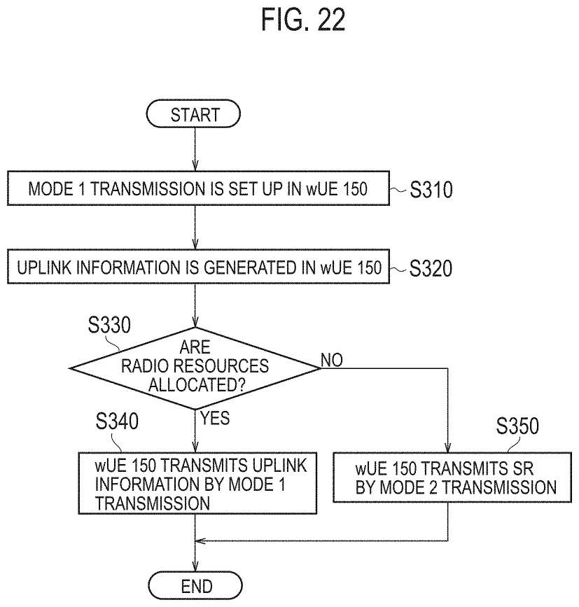

The operation example 8 will be described with reference to FIG. 22. FIG. 22 is a diagram for describing the operation example 8. The description of parts similar to those described above will not be repeated.

The operation example 8 is a case where the PUCCH related information is a scheduling request.

In the operation example 8, the wUE 150 is set up for transmitting a scheduling request on the first uplink path (SL).

In step S310, mode 1 transmission is set up in the wUE 150, in order to transmit the uplink information on the first uplink path (SL). The wUE 150 may be set up for the mode 1 transmission by receiving the setting information from the eNB 200. Therefore, the setting information indicates a setting for using the radio resource allocated from the eNB 200, in a case where the uplink information is transmitted to the UE 150. The mode 1 transmission may be set up in the wUE 150, based on the setting information of a relay using the proximity service (ProSe UE-to-Network Relaying). The wUE 150 may be set up for transmitting the uplink information on the first uplink path (SL), according to the setting information. The eNB 200 may transmit setting information to the wUE 150, by dedicated signaling (such as RRC reconfiguration message, for example) and/or broadcast signaling (for example, SIB).

In step S320, uplink information is generated in the wUE 150.

In step S330, the wUE 150 determines whether or not radio resources for transmitting uplink information to the UE 100 are allocated. In a case where the radio resources are allocated, the wUE 150 executes a process of step S340. In a case where the radio resources are not allocated, the wUE 150 executes a process of step S350.

In step S340, the wUE 150 transmits uplink information to the UE 100, by the mode 1 transmission. That is, the wUE 150 transmits the uplink information to the UE 100, by using a radio resource allocated from the eNB 200. The UE 100 transmits (forwards/relays) the uplink information to the eNB 200.

In step S350, the wUE 150 transmits a scheduling request to the UE 100, by the mode 2 transmission.

Since a radio resource for uplink information transmission is not allocated from the eNB 200, the wUE 150 autonomously selects a radio resource from the resource pool. That is, regardless that the mode 1 transmission is set up in the wUE 150, the wUE 150 exceptionally executes operation of the mode 2 transmission.

A resource pool includes a plurality of radio resources. The resource pool may be a resource pool for terminal-to-terminal communication. The resource pool may be a resource pool for a scheduling request. The resource pool may be an exceptional resource pool.

Resource pool information may be included in the setting information described above. In a case where the uplink information is generated in the wUE 150, the wUE 150 may acquire the resource pool information broadcast from the eNB 200, for example, in SIB. The wUE 150 may identify the resource pool based on the resource pool information.

The wUE 150 transmits a scheduling request to the UE 100 using the selected radio resource. The scheduling request is a request to request radio resources for transmitting the generated uplink information to the eNB 200. The wUE 150 may send information indicating data quantity of the uplink information together with the scheduling request.

The UE 100 transmits (forwards/relays) the scheduling request from the wUE 150 to the eNB 200. Until the radio resource for the mode 1 transmission is allocated, the UE 100 may monitor a resource pool for the mode 2 transmission. The UE 100 may receive, from the eNB 200, setting information to be set to the wUE 150. The UE 100 may receive, from the wUE 150, the setting information (resource pool information). In a case where the UE 100 operates as a relay UE of the wUE 150, the UE 100 may acquire the resource pool information from the eNB 200 (for example, in SIB) in advance.

The eNB 200 allocates radio resources to the wUE 150, based on the scheduling request received from the wUE 150 (UE 100) through the first uplink path (SL). The eNB 200 notifies the wUE 150 (and the UE 100) of the allocated radio resource information, through the second downlink path (Uu).

The wUE 150 transmits the uplink information to the UE 100, by mode 1 transmission using the allocated radio resource. The UE 100 transmits (forwards/relays) the uplink information from the wUE 150 to the eNB 200.

As described above, even though the mode 1 transmission is set up, the wUE 150 may exceptionally execute the mode 2 transmission in a case where the radio resource pool is not allocated. In this way, the wUE 150 is able to transmit the uplink information without delay.

### Other Embodiments

Although the contents of the present application have been described according to the embodiments described above, it should not be understood that the contents of the present application is not limited to descriptions and drawings configuring a part of this disclosure. In view of the disclosure, various alternative embodiments, examples and operational techniques will be apparent to those skilled in the art.

In the above description, control information (control information related to the relay UE) in the RRC layer has been mainly described as control information transmitted between the remote UE and the network, but the present invention is not limited thereto. The control information may be control information other than the RRC layer. For example, the control information may be control information in at least one of a physical layer, an RLC layer, a PDCP layer, and a NAS layer. Since the control information transmission is enabled between the remote UE and the network, the network is able to recognize the control information related to the remote UE, similarly to the control information related to a normal UE 100. In this way, the network (such as the eNB 200 and the MME 300, for example) is able to control the remote UE, similarly to the normal UE 100. For example, the remote UE is able to perform location registration on the network, similarly to the normal UE 100. In this way, the network is able to appropriately provide a (communication) service to the remote UE.

In the operation example 6 described above, the UE 100 may transmit a NACK from the wUE 150 to the eNB 200, in a case where the UE 100 has failed to receive the downlink information addressed to the wUE 150.

In a case where the UE 100 has failed to receive downlink information addressed to the wUE 150, the UE 100 may send the following notification to the eNB 200. The UE 100 may send, to the eNB 200, a notification indicating that the UE 100 has failed to receive downlink information. The UE 100 may send a notification indicating that the UE 100 does not execute retransmission (is unable to execute retransmission). In a case where the UE 100 does not attempt to receive downlink information (that is, in a case where retransmission processing is not executed), the UE 100 may send the notification to the eNB 200. The UE 100 may send the notification to the eNB 200, regardless of whether it is before or after the UE 100 receives the NACK from the wUE 150. The eNB 200 is able to be aware of retransmission by the UE 100, according to a notification from the UE 100. In a case where the eNB 200 has received the NACK from the UE 100, the eNB 200 may execute the retransmission of the downlink information through the second downlink path (Uu).

In a case where the eNB 200 has received, from the UE 100, a notification indicating that the UE 100 failed to receive the downlink information, the eNB 200 may execute the retransmission of the downlink information through the second downlink path (Uu). There is a high possibility that the wUE 150 fails to receive the downlink information because a position of the UE 100 is close to a position of the wUE 150. In this way, it is possible to reduce delay time until the downlink information is retransmitted to the wUE 150.

In the above description, a signaling between the relay UE and the remote UE has been mainly described as a sidelink signal (PC5 signaling), but the present invention is not limited thereto. The signaling between the relay UE and the remote UE may be signaling through a non-3GPP interface. The signaling between the relay UE and the eNB 200 may be signaling in the LTE system. The relay UE and the remote UE may have an RRC layer on the non-3GPP interface. The relay UE and the remote UE may transmit the control information, by using the RRC layer.

In the embodiments described above, the wUE 150 (a wearable UE) has been described as an example as a remote UE, but the present invention is not limited thereto. The wUE 150 may be a normal UE 100. The contents described above may be applied to a communication device in a moving object (for example, a vehicle), which is connected to a network, and a UE in the moving object (or an Internet of Things (IoT) device in the moving object). The contents described above may be applied to communication devices for machine type communication (Machine Type Communication (MTC)) which is a communication not involving any person.

The operations (operation examples) according to the embodiments described above may be combined to be executed, where necessary. In each of sequences described above, all of the operations may not be necessarily essential. For example, in each sequence, only some of the operations may be executed.

Although not particularly mentioned in the embodiments described above, a program for causing a computer to execute each process performed by any one of the nodes described above (such as the UE 100 and the eNB 200) may be provided. The program may be recorded on a computer-readable medium. If the computer-readable medium is used, it is possible to install the program on a computer. Here, the computer-readable medium recording therein with the program may be a non-transitory recording medium. The non-transitory recording medium may include, but not be limited to, a recording medium such as a CD-ROM and a DVD-ROM, for example.

Alternatively, a chip may be provided which includes: a memory for storing a program for executing each process performed by any one of the UE 100 and the eNB 200; and a processor) for executing the program stored in the memory.

In the embodiments described above, an LTE system is described as an example of the mobile communication system; however, the LTE system is not an exclusive example, and the contents according to the present application may be applied to a system other than the LTE system.

[Supplementary Note]

(1) Discussion

(A) UE Terminated Service via Relaying

Regarding current ProSe UE-to-NW Relay scheme, Relay UE performs the Remote UE Report procedure whereby the procedure means the Relay UE informs the NW of the information of Remote UEs which establish the PC5 connection with Relay UE, which enables the NW to transmit/receive traffic from/to Remote UEs. However, if the Remote UE wants to receive the UE terminated service based on the current specification, the Remote UE needs to maintain the PC5 connection with the Relay UE even though the Remote UE doesn't have the traffic available for transmission. According to the objective of the SID, there is the statement that “The primary objective of the study is to address power efficiency for evolved Remote UEs (e.g. wearable devices)”; therefore, it should be considered how the UE terminated service can reach the Remote UE which doesn't establish PC5 connection with the Relay UE.

Proposal 1: It should consider how the UE terminated service can reach the Remote UE which doesn't establish PC5 connection with Relay UE.

It should be considered how the Relay UE knows the arrival of the Remote UE's traffic. According to the current L3 ProSe UE-to-NW relay architecture, the Relay UE in RRC_CONNECTED uses the IP address of the Remote UE to determine the arrival of the Remote UE terminated service. Even though the Relay UE in RRC_IDLE can reuse this scheme, the traffic to the Remote UE may be delayed because the Relay UE in RRC_IDLE will notice the arrival of the Remote UE terminated service after completion of RRC connection establishment procedure. So it may be helpful to enhance the paging scheme to inform the Relay UE of the arrival of the Remote UE traffic.

Proposal 2: It should consider whether to enhance the paging scheme to inform the Relay UE of the arrival of the Remote UE traffic.

(B) CP Relaying

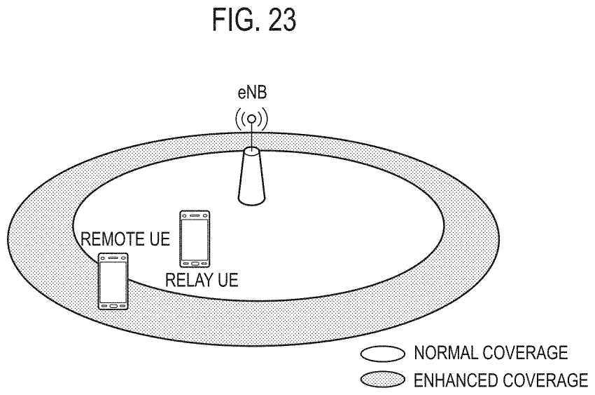

Considering the CP relaying, assuming the Remote UE is within the enhanced coverage (FIG. 23), CP Relaying will be useful to improve the Remote UE's power efficiency. The Remote UE in the enhanced coverage may need to transmit/receive the signalling messages repeatedly, so if the Remote UE is configured with a large number of the repetitions, relaying the CP signalling will be helpful for improving the Remote UE's power efficiency.

With regards to the RRC connection establishment procedure within the enhanced coverage, CP relaying will also be helpful to reduce the need for the remote UE to, for transmit random access preamble repeatedly. This should also improve so the power efficiency of the Remote UE under this scenario.

Proposal 3: It should allow the Remote UE in the enhanced coverage to initiate the RRC connection establishment procedure via relaying.

The entire contents of U.S. Provisional Application No. 62/402,230 (filed on Sep. 30, 2016) are incorporated herein by reference.

1. A communication control method, comprising:
executing, by a first radio terminal, control to establish a predetermined connection through a second radio terminal that is a relay terminal,
using the predetermined connection to transmit control information related to the first radio terminal between the first radio terminal and a base station; and
starting, by the first radio terminal, control to establish the predetermined connection, in response to receiving authorization information indicating that possible to establishing the predetermined connection is possible.

2. The communication control method according to claim 1, wherein the first radio terminal receives the authorization information from the base station.

3. The communication control method according to claim 1, wherein the first radio terminal receives the authorization information from the second radio terminal.

4. The communication control method according to claim 1, further comprising:
receiving, by the first radio terminal, specification information indicating a first path or a second path as a downlink path,
the first path being a path from the base station to the first radio terminal via the second radio terminal, and
the second path being a path from the base station to the first radio terminal not via the second radio terminal; and
receiving, by the first radio terminal, downlink information from the base station through the first path or the second path, based on the specification information.

5. A communication control method, comprising:
transmitting, by a first radio terminal to a base station, uplink information through an uplink path from the first radio terminal to the base station via a second radio terminal that is a relay terminal;
receiving, by the first radio terminal from the base station, downlink information through a downlink path from the base station to the first radio terminal not via the second radio terminal;
receiving, by the first radio terminal, specification information specifying a first uplink path or a second uplink path, as a path through which PUCCH related information is to be transmitted on a physical uplink control channel,
the first uplink path being a path from the first radio terminal to the base station via the second radio terminal, and
the second uplink path being a path from the first radio terminal to the base station not via the second radio terminal; and
transmitting, by the first radio terminal, the PUCCH related information to the base station through the first uplink path or the second uplink path, based on the specification information.

6. The communication control method according to claim 5, wherein the PUCCH related information is at least one of acknowledgment information, channel state information, and a scheduling request in response to the downlink information.

7. The communication control method according to claim 5, wherein
the PUCCH related information is acknowledgment information in response to the downlink information, the method further comprising:
acquiring, by the second radio terminal, the downlink information from the base station;
transmitting, by the first radio terminal, the acknowledgment information to the second radio terminal; and
retransmitting, by the second radio terminal, the downlink information to the first radio terminal, instead of the base station, in response to the acknowledgment information being negative information.

8. The communication control method according to claim 7, further comprising:
receiving, by the second radio terminal, an identifier for acquiring the downlink information from the first radio terminal or the base station; and
acquiring, by the second radio terminal, the downlink information using the identifier.

9. The communication control method according to claim 5, wherein
the PUCCH related information is acknowledgment information in response to the downlink information, the method further comprising:
notifying, by the base station, the first radio terminal of a reception period of the acknowledgment information, in a case where the base station receives the acknowledgment information from the first radio terminal through the first uplink path; and
starting, by the base station, retransmission of the downlink information, in response that the base station is unable to receive the acknowledgment information even after the reception period has elapsed.

10. The communication control method according to claim 5, wherein
the PUCCH related information is acknowledgment information in response to the downlink information, the method further comprising:
receiving, by the second radio terminal, the acknowledgment information from the first radio terminal; and
transmitting, by the second radio terminal, to the base station, the acknowledgment information in preference to other information to be transmitted to the base station.

11. The communication control method according to claim 5, further comprising:
receiving, by the first radio terminal, setting information,
indicating, by the setting information, a setting for using a radio resource allocated from the base station, in a case where the uplink information is transmitted to the second radio terminal;
autonomously selecting, by the first radio terminal, a radio resource from a resource pool, in a case where the uplink information is generated before the radio resource is allocated from the base station; and
transmitting, by the first radio terminal, to the second radio terminal, a scheduling request for requesting a radio resource to the base station, by using the selected radio resource.
